(19) United States
(12) Patent Application Publication
(10) Pub. No.: US 2017/0019550 A1
(43) Pub. Date: Jan. 19, 2017

(54) INFORMATION PROCESSING APPARATUS, IMAGE PROCESSING SYSTEM, AND INFORMATION PROCESSING METHOD

(71) Applicants: Makoto SASAKI, Kanagawa (JP); Tomohiro KUROYANAGI, Tokyo (JP); Hiroyuki SAKUYAMA, Tokyo (JP); Koichiro MAEMURA, Kanagawa (JP); Fumiyoshi KITTAKA, Kanagawa (JP); Tohru SASAKI, Kanagawa (JP); Atsushi OKAZATO, Kanagawa (JP); Junki AOKI, Kanagawa (JP); Takuya MORI, Tokyo (JP)

(72) Inventors: Makoto SASAKI, Kanagawa (JP); Tomohiro KUROYANAGI, Tokyo (JP); Hiroyuki SAKUYAMA, Tokyo (JP); Koichiro MAEMURA, Kanagawa (JP); Fumiyoshi KITTAKA, Kanagawa (JP); Tohru SASAKI, Kanagawa (JP); Atsushi OKAZATO, Kanagawa (JP); Junki AOKI, Kanagawa (JP); Takuya MORI, Tokyo (JP)

(21) Appl. No.: 15/202,077

(22) Filed: Jul. 5, 2016

(30) Foreign Application Priority Data
Jul. 15, 2015 (JP) 2015-141559

(51) Int. Cl. H04N 1/00

(52) U.S. Cl. CPC H04N 1/00923; H04N 1/00344; H04N 2201/0094; H04N 2201/0039

(57) ABSTRACT

An information processing apparatus includes circuitry that receives multiple output commands from one or more inputting image processing apparatuses, each command instructing to output image data through an outputting information processing apparatus, acquires a status of the outputting image processing apparatus, determines priorities of the multiple output commands to be transferred to the outputting image processing apparatus based on the acquired status of the outputting image processing apparatus, and modifies an order of processing the output commands in accordance with the determined priorities of the output commands.

### CROSS-REFERENCE TO RELATED APPLICATIONS

This patent application is based on and claims priority pursuant to 35 U.S.C. §119(a) to Japanese Patent Application No. 2015-141559, filed on Jul. 15, 2015 in the Japan Patent Office, the entire disclosures of which are hereby incorporated by reference herein.

### BACKGROUND

Technical Field

The present invention relates to an information processing apparatus, an image processing system, and an information processing method.

Background Art

With increased computerization of information, image processing apparatuses such as printers and facsimiles used for outputting the computerized information and scanners used for computerizing documents have become indispensable. In most cases, these image processing apparatuses are configured as multifunction peripherals (MFPs) that can be used as a printer, facsimile, scanner, and copier by implementing an image pickup capability, image forming capability, and communication capability, etc.

A technology that connects multiple image processing apparatuses to an information processing apparatus such as a personal computer (PC) via a network to implement a function that cannot be implemented by a stand-alone apparatus by cooperating with other apparatuses has been proposed. Among such technologies, a technology that prioritizes multiple commands to output including image information (hereinafter referred to as “output job”) and modifies the order of processing the output jobs to enhance productivity in printing of the image processing apparatus is known.

### SUMMARY

Example embodiments of the present invention provide a novel information processing apparatus includes circuitry that receives multiple output commands from one or more inputting image processing apparatuses, each command instructing to output image data through an outputting information processing apparatus, acquires a status of the outputting image processing apparatus, determines priorities of the multiple output commands to be transferred to the outputting image processing apparatus based on the acquired status of the outputting image processing apparatus, and modifies an order of processing the output commands in accordance with the determined priorities of the output commands.

Further embodiments of the present invention provide an image processing system, and an information processing method.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an image processing system as an embodiment of the present invention.

FIG. 2 is a block diagram illustrating a hardware configuration of an image processing apparatus as an embodiment of the present invention.

FIG. 3 is a block diagram illustrating a hardware configuration of an information processing apparatus as an embodiment of the present invention.

FIG. 4 is a block diagram illustrating a functional configuration of the image processing apparatus as an embodiment of the present invention.

FIG. 5 is a block diagram illustrating a configuration of an output job management function in the image processing apparatus as an embodiment of the present invention.

FIG. 6 is a block diagram illustrating a functional configuration of a system management server as an embodiment of the present invention.

FIG. 7 is a flowchart illustrating a whole operation of the system management server as an embodiment of the present invention.

FIG. 8 is a flowchart illustrating an operation of acquiring a status of the image processing apparatus by a network controller as an embodiment of the present invention.

FIG. 9 is a diagram illustrating an output apparatus status table indicating a status of the image processing apparatus as an embodiment of the present invention.

FIG. 10 is a flowchart illustrating an operation of determining a priority of an output job by a priority determination unit (determining unit) as an embodiment of the present invention.

FIG. 11 is a diagram illustrating a job list indicating information on the output job stored in the system management server as an embodiment of the present invention.

FIG. 12 is a flowchart illustrating an operation of modifying an order of processing output jobs by an order modifier as an embodiment of the present invention.

FIG. 13 is a diagram illustrating an operation of modifying an order of processing output jobs transferred to the image processing apparatus in the system management server as an embodiment of the present invention.

FIG. 14 is a diagram illustrating an operation of modifying an order of processing output jobs transferred to the client terminal in the system management server as an embodiment of the present invention.

FIG. 15 is a diagram illustrating a screen displayed on a display panel of the image processing apparatus as an embodiment of the present invention.

FIG. 16 is a diagram illustrating an output apparatus status table as an embodiment of the present invention.

FIG. 17 is a diagram illustrating a job list as an embodiment of the present invention.

FIG. 18 is a flowchart illustrating an operation of determining a priority of an output job by a priority determining unit as an embodiment of the present invention.

FIG. 19 is a diagram illustrating an operation of modifying an order of processing output jobs transferred to the image processing apparatus in the system management server as an embodiment of the present invention.

FIG. 20 is a diagram illustrating a job list as an embodiment of the present invention.

FIGS. 21A and 21B are flowcharts illustrating an operation of determining a priority of an output job by a priority determining unit as an embodiment of the present invention.

FIG. 22 is a diagram illustrating an operation of modifying an order of processing output jobs transferred to the image processing apparatus in the system management server as an embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

A more complete appreciation of the disclosure and many of the attendant advantages thereof will be readily obtained as the same becomes better understood by reference to the following detailed description when considered in conjunction with the accompanying drawings.

Embodiments of the present invention are described below in detail with reference to figures. In figures, same symbols are assigned to same or corresponding parts, and their descriptions are simplified or omitted appropriately.

In the known technology, in the cooperation system including the image processing apparatus and the information processing apparatus, an output job is transferred to the image processing apparatus on an output end from the image processing apparatus on an input end via the information processing apparatus in some cases. In that case, the information processing apparatus that relays the output jobs transfers the output jobs in order of receiving the output jobs from the image processing apparatus on the input end.

As a result, if a transferred output job (hereinafter referred to as “a precedence job”) is not processed immediately and another output job (hereinafter referred to as “a subsequent job”) that the image processing apparatus on the output end can execute immediately after transferring the precedence job, processing the subsequent job does not start until processing the precedence job finishes. The precedence job is not processed immediately if the image processing apparatus on the output side already has another output job to be executed for example.

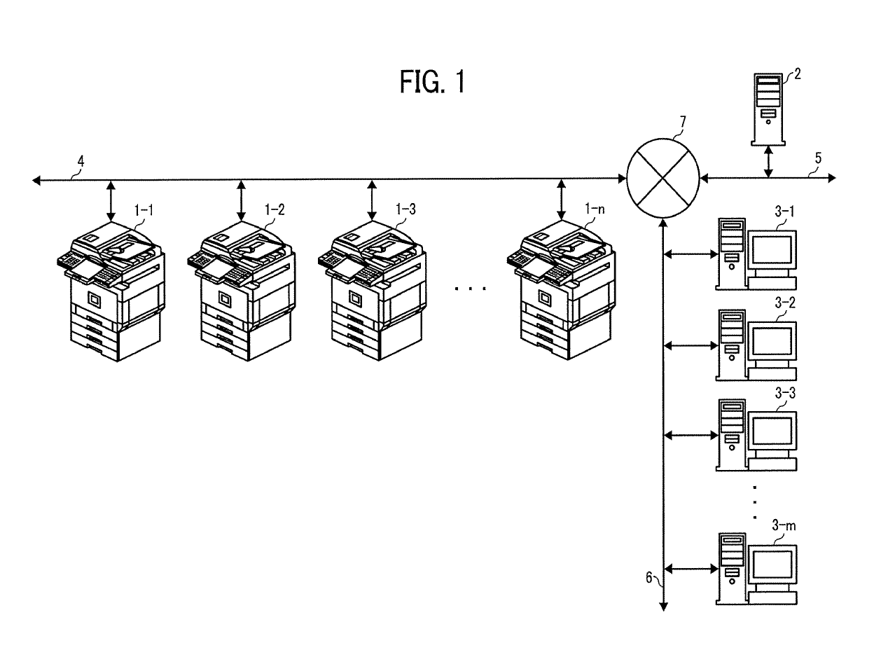

First, operation of an image processing system in a first embodiment is described below with reference to FIG. 1. FIG. 1 is a diagram illustrating an image processing system in this embodiment.

As illustrated in FIG. 1, in the image processing system in this embodiment, a network 4 that connects image processing apparatuses 1-1 to 1-n (i.e., n is a natural number), a network 5 that connects a system management server 2, and a network 6 that connects client terminals 3-1 to 3-m (i.e., m is a natural number) are connected with each other via a public network such as the internet or a telephone network etc.

In the description below, if it is unnecessary to distinguish each of the image processing apparatuses 1-1 to 1-n respectively, those image processing apparatuses are collectively referred to as an image processing apparatus 1. Likewise, if it is unnecessary to distinguish each of the client terminals 3-1 to 3-m respectively, those client terminals are collectively referred to as a client terminal 3.

The numbers of the image processing apparatus 1 connected to the network 4 and the client terminals 3 connected to the network 6 are just examples, and it is possible to connect more number of apparatuses in a larger system. In addition, it is possible that multiple networks that connect different image processing apparatuses 1 respectively are connected to the system management server 2 and the client terminal 3 via the public network 7.

In addition, it is possible that multiple networks that connect different client terminals 3 respectively are connected to the system management server 2 and the client terminal 3 via the public network 7. In addition, it is possible that the image processing apparatus 1, the system management server 2, and the client terminal 3 are connected to the same network.

For example, the networks 4 to 6 are limited networks such as an office local area network (LAN). While the image processing apparatus 1, the system management server 2, and the client terminal 3 are connected to the public network via each LAN respectively, it is possible that the image processing apparatus 1, the system management server 2, and the client terminal 3 are connected to the public network directly.

In addition, it is possible to implement the networks 4 to 6 using a network compatible with interfaces such as Ethernet, Universal Serial Bus (USB), Bluetooth, Wireless Fidelity (Wi-Fi), FeliCa, and the Institute of Electrical and Electronics Engineers (IEEE) standard etc.

The image processing apparatus 1 is a MFP that implements an image pickup capability, image forming capability, and communication capability and can be used as a printer, facsimile, scanner, and copier. As a result, the image processing apparatus 1 functions as an inputting image processing apparatus that receives image information, generates commands to output such as a print output command etc. (hereinafter referred to as “output job”), and transfers the generated commands to output to the system management server 2. In addition, the image processing apparatus 1 functions as an outputting image processing apparatus that receives the output job from the system management server 2 and performs an image processing such as printing etc.

In the following embodiment, in order to describe the configuration of the image processing system in this embodiment in a way easy to understand, the image processing apparatus that functions as the inputting image processing apparatus is referred to as the image processing apparatus 1A, and the image processing apparatus 1 that functions as the outputting image processing apparatus is referred to as the image processing apparatus 1B.

The system management server 2 functions as a cooperating server that cooperates with the image processing apparatuses 1A and 1B and client terminal 3 via the network, and the system management server 2 is configured by the information processing apparatus that stores and manages the output job from the image processing 1A. In addition, the system management server 2 transfers the output job to the image processing apparatus 1B, transfers the image information included in the output job, and transfers e-mail etc.

The client terminal 3 is an information processing device such as a personal computer (PC) operated by user operation. It is possible to implement the client terminal 3 using a portable device such as a personal digital assistant (PDA), smartphone, and tablet device etc.

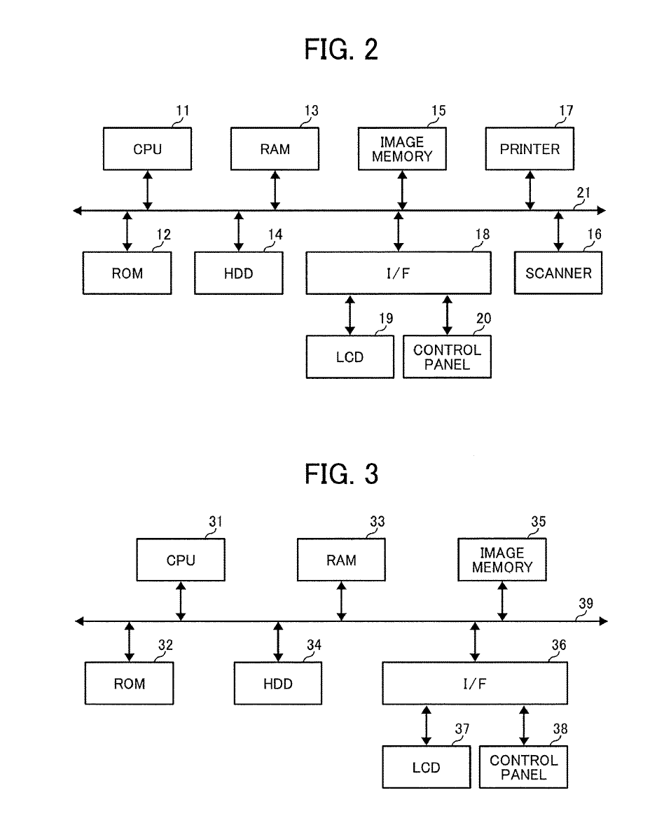

Next, a hardware configuration of the image processing apparatuses 1A and 1B included in the image processing system in this embodiment is described below in detail with reference to FIG. 2. FIG. 2 is a block diagram illustrating a hardware configuration of the image processing apparatuses 1A and 1B in this embodiment. As illustrated in FIG. 1, the image processing apparatuses 1A and 1B in this embodiment include the same configuration as a general PC etc.

That is, in the image processing apparatuses 1A and 1B in this embodiment, a central processing unit (CPU) 11, a read only memory (ROM) 12, a random access memory (RAM) 13, a hard disk drive (HDD) 14, an image memory 15, a scanner 16, a printer 17, and an interface (I/F) 18 are connected with each other via a bus 21. In addition, a Liquid Crystal Display (LCD) 19 and a control panel 20 are connected to the I/F 18. The image processing apparatuses 1A and 1B include an engine that executes forming an image and outputting the image.

The CPU 11 is a processor and controls the whole operation of the image processing apparatuses 1A and 1B. The ROM 12 is a read-only non-volatile storage medium and stores programs such as firmware. The RAM 13 is a volatile memory that can read/write information at high speed and is used as a work area when the CPU 11 processes information. The HDD 14 is a non-volatile storage medium that can read/write information and stores the operating system (OS), various control programs, and application programs etc. In addition, the HDD 14 stores authentication information of users who can use the image processing apparatuses 1A and 1B. In addition to the HDD 14, semiconductor memories such as a Solid State Drive (SSD) can be used.

The image memory 15 is a nonvolatile storage medium that can read and write data, and the image memory 15 stores the scanned image information and compressed image information etc. The scanner 16 is implemented by a scanning device that scans an image on a document as the image information. The printer 17 is implemented by a printing device that forms an image on paper stored inside preliminarily.

The I/F 18 connects the bus 21 with various hardware and network etc. to control such hardware and network. The LCD 19 is a visual user interface to check status of the image processing apparatuses 1A and 1B. The control panel 20 is a user interface such as a keyboard, mouse, various hardware buttons, and touch panel to input information to the image processing apparatuses 1A and 1B by user operation.

In this hardware configuration described above, programs stored in storage devices such as the ROM 12, HDD 14, and optical discs are read to the RAM 13, and a software controlling unit is constructed by executing operation in accordance with the programs by the CPU 11. Functional blocks that implement functions of apparatuses that consist of the image processing system of this embodiment are constructed by a combination of the software controlling units described above and hardware. Next, a hardware configuration of the information processing apparatus that constructs each of the system management server 2 and the client terminal 3 included in the image processing system in this embodiment is described below with reference to FIG. 3. FIG. 3 is a block diagram illustrating a hardware configuration of the information processing apparatus in this embodiment. As illustrated in FIG. 3, while the basic configuration of the information processing apparatus in this embodiment is the same as the image processing apparatuses 1A and 1B, the scanner 16 and the printer 17 in the image processing apparatuses 1A and 1B are not included in the hardware configuration of the information processing apparatus in this embodiment.

That is, in the information processing apparatus in this embodiment, a CPU 31, a ROM 32, a RAM 33, a HDD 34, an image memory 35, and an I/F 36 are connected with each other via a bus 39. In addition, a Liquid Crystal Display (LCD) 37 and a control panel 38 are connected to the I/F 36. Since the components described above in the information processing apparatus have similar functions as the corresponding components of the image processing apparatuses 1A and 1B described above, redundant descriptions for the components in the information processing apparatus are omitted.

In the system management server 2 that includes the configuration described above, each of the image processing apparatuses 1A and 1B are registered preliminarily, and it is possible to communicate with the image processing apparatuses 1A and 1B concurrently. In addition, any one of the image processing apparatuses 1A and 1B acquires IP address as the authentication information of another image processing apparatuses via the system management server 2, and it is possible to communicate with the other image processing apparatus.

The image processing apparatuses 1A and 1B in this embodiment is located in a building that manages users using ID cards when users enter/leave the building and users enter/leave a room. In addition, the system management server 2 is connected to be communicable to a counting system that counts the number of users in the building and the room based on the management information of the ID cards. As a result, in accordance with an inquiry by each of the image processing apparatuses 1A and 1B, the system management server 2 can report the number of users in the building and the room at that time to each of the image processing apparatus 1A and 1B.

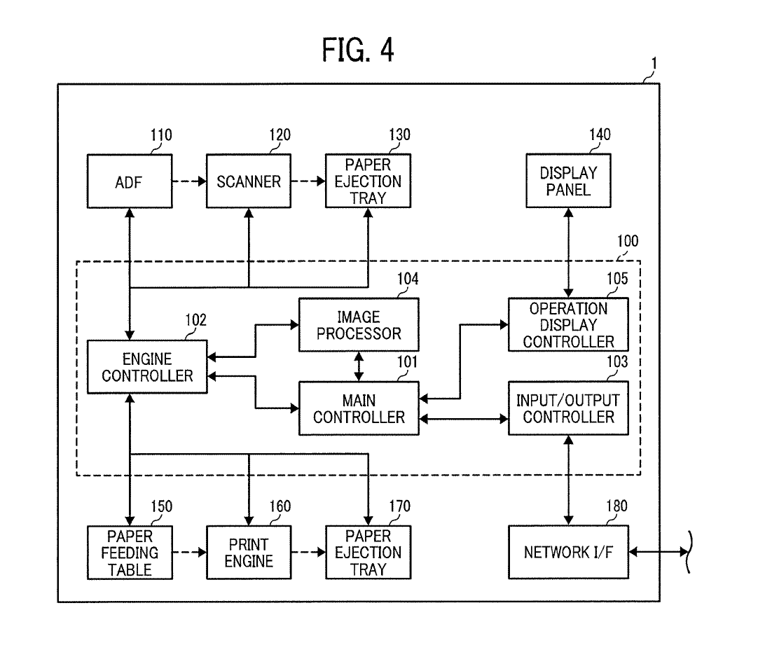

Next, functions of the image processing apparatuses 1A and 1B in this embodiment are described below. FIG. 4 is a block diagram illustrating a functional configuration of the image processing apparatus in this embodiment. As illustrated in FIG. 4, the image processing apparatuses 1A and 1B in this embodiment include a controller 100, an Auto Document Feeder (ADF) 110, a scanner 120, a paper ejection tray (paper output tray) 130, a display panel 140, a paper feeding table (paper feed table) 150, a print engine 160, a paper ejection tray 170, and a network I/F 170.

The controller 100 includes a main controller 101, an engine controller 102, an input/output controller 103, an image processor 104, and an operational display controller 105. As illustrated in FIG. 4, the image processing apparatuses 1A and 1B in this embodiment are constructed as the MFP that includes the scanner 120 and the print engine 160. It is possible that the image processing apparatus 1A does not include the print engine 160 and the image processing apparatus 1B does not include the scanner 120. In FIG. 4, solid arrows indicate electrical connections, and dashed arrows indicate flow of paper a bundle of documents. The display panel 140 is an output interface that functions as a display device that displays a status of the image processing apparatuses 1A and 1B visually. The display panel 140 is also an input interface (control panel) that accepts user operation to operate the image processing apparatuses 1A and 1B directly as a touch panel and input information to operate the image processing apparatuses 1A and 1B by user operation. For example, on the display panel 140, user operations to configure the image processing apparatuses 1A and 1B and display the status of the image processing apparatuses 1A and 1B are performed. Regarding the shape and the display of the display panel 140, it is possible to implement various variations.

The network I/F 180 is an interface that the image processing apparatuses 1A and 1B communicates with other apparatuses such as the system management server 2 and the client terminal 3 etc. via the networks 4 to 6, and Ethernet and USB interface are used for the network I/F 180 for example.

The controller 100 is implemented by a combination of software and hardware. More specifically, the controller 100 corresponds to a software controller implemented by performing calculation by the CPU 11 in accordance with those programs and hardware such as integrated circuits etc. The program used by the CPU 11 to perform calculation is stored in the ROM 12 and loaded from the nonvolatile storage medium such as the HDD 14 into the RAM 13. The controller 100 functions as a controller that controls the whole part of the image processing apparatuses 1A and 1B. The main controller 101 controls each unit included in the controller 100 and commands each unit in the controller 100. The engine controller 102 controls and drives the print engine 160 and the scanner 120. The input/output controller 103 inputs signals and commands input via the network I/F 180 to the main controller 101. The main controller 101 controls the input/output controller 103 to access another apparatus via the network I/F 180 and the networks 4 to 6.

The image processor 104 generates drawing information based on image information to be printed and output under the control of the main controller 101. The drawing information is information that the print engine 160 as an image forming unit draws as an image to be formed in an image forming operation. The image processor 104 processes image pickup data input from the scanner 120 and generates image data. The generated image data is stored in the image forming apparatuses 1A and 1B as a result of the scanning operation or transferred to another apparatus via the network I/F 180. The operation display controller 105 displays information on the display panel 140 and reports information input via the display panel 140 to the main controller 101. If the image processing apparatuses 1A and 1B function as the printer, first, the input output controller 103 receives an output job (a print job) via the network I/F 180. The input/output controller 103 transfers the received output job to the main controller 101. After receiving the print job, the main controller 101 generates the drawing information based on the document information and image information included in the output job by controlling the image processor 104.

After the image processor 104 generates the drawing information, the engine controller 102 executes forming an image on paper carried from the paper feed table 150 based on the generated drawing information. As particular examples of the print engine 160, image forming mechanisms such as inkjet method and electrophotography method can be used. After the print engine 160 forms the image on the paper, the paper is ejected on the paper output tray 170.

If the image processing apparatuses 1A and 1B function as a scanner, in response to a command to execute scanning input by operation on the display panel 140 or from an external apparatus, the operational display controller 105 or the input/output controller 103 transfers a signal to execute scanning to the main controller 101. The main controller 101 controls the engine controller 102 based on the received signal to execute scanning. The engine controller 102 drives the ADF 110 and carries a document to be scanned set on the ADF 110 to the scanner unit 120.

In addition, the engine controller 102 drives the scanner 120 and scans the document carried from the ADF 110. If the document is not set on the ADF 110 and the document is set on the scanner 120 directly, the scanner 120 scans the set document under the control of the engine controller 102. That is, the scanner 120 functions as the image pickup unit.

In scanning operation, an image pickup device such as CCD included in the scanner 120 scans the document optically, and image pickup information is generated based on the optical information. The engine controller 102 transfers the image pickup information generated by the scanner 120 to the image processor 104. The image processor 104 generates the image information based on the image pickup information received from the engine controller 102 under the control of the main controller 101.

The image information generated by the image processor 104 is stored in the storage device such as the HDD 14 attached to the image processing apparatuses 1A and 1B. The image information generated by the image processor 104 is either stored in the HDD 14 etc. as is or transferred to an external apparatus by the input/output controller 103 via the network I/F 180 depending on the user command.

If the image processing apparatuses 1A and 1B function as a copier, the image processor 104 generates the drawing information based on either the image pickup information received from the scanner 120 by the engine controller 102 or the image information generated by the image processor 104. Similarly as the printer operation, the engine controller 102 drives the print engine 160 based on the drawing information.

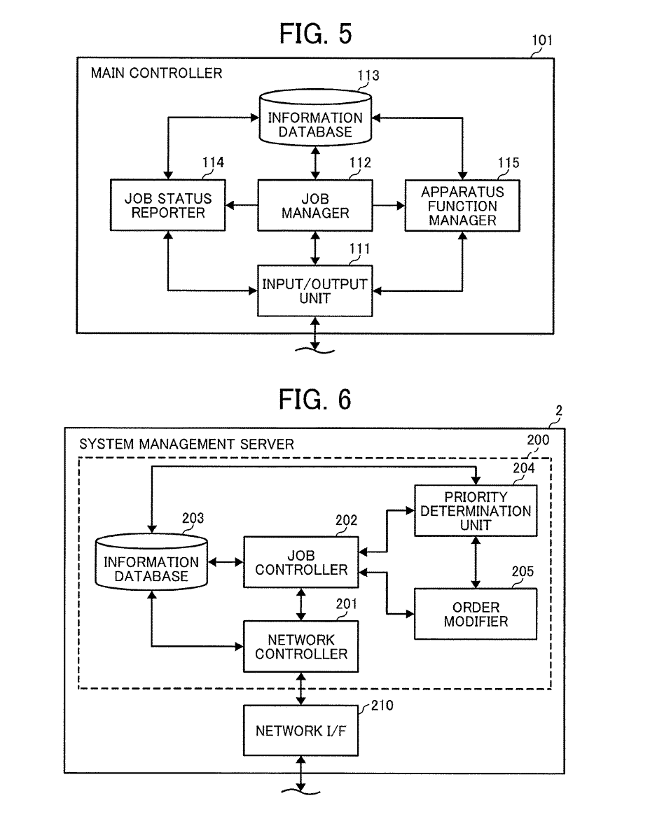

Next, functions of receiving an output job and determining whether or not the output job is executed among functions of the main controller 101 in this embodiment are described in detail below with reference to FIG. 5. As illustrated in FIG. 5, the main controller 101 in this embodiment includes an input/output unit 111, a job manager 112, an information database (DB) 113, a job status reporter 114, and an apparatus function manager 115.

The input/output unit 111 processes information input to the main controller 101 and information that the main controller 101 outputs. The job manager 112 manages an output job such as a print job and a copy job received from the system management server 2 via the network 4 and 5. In addition, the job manager 112 processes the output job in accordance with various control programs and application programs stored in the HDD 14 etc. preliminarily and finishes processing the output job by controlling the input/output unit 111. The information DB 113 stores information on the output job received from the system management server 2, information for processing images after receiving the output job, and apparatus information regarding apparatuses connected to the networks 4 to 6. The job status reporter 114 monitors a status of the output job executing or idling on the image processing apparatus 1B and reports the status of the image processing apparatus 1B to an outside apparatus via the input/output unit 111. The apparatus function manager 115 manages capabilities and functions included in the image processing apparatuses 1A and 1B such as the apparatus configuration including the scan function (scanner function) and the print function and processing capability etc.

By adopting the configuration described above, the image information generated by scanning etc. is input to the image processing apparatus 1A in this embodiment. Subsequently, an output job including a command such as printing an image on paper remotely based on the image information and transferring image information after performing optical character recognition on the image information etc. for the system management server 2. By contrast, the image processing apparatus 1B in this embodiment stores the output job received from the system management server 2 temporarily and processes images such as printing and transferring FAX in accordance with the output job sequentially in the order of being received.

Next, a functional configuration of the system management server 2 in this embodiment is described in detail below with reference to FIG. 6. As illustrated in FIG. 6, the system management server 2 in this embodiment includes a controller 200 and a network I/F 210. In addition, the controller 200 includes a network controller 201, a job controller 202, an information DB 203, a priority determination unit (determining unit) 204, and an order modifier 205.

The network I/F 210 is an interface that the system management server 2 communicates with other apparatuses such as the image processing apparatuses 1A and 1B and the client terminal 3 etc. via the networks 4 to 6, and Ethernet is used for the network I/F 210 for example. The network I/F 210 is implemented by the I/F 36 in FIG. 3.

The controller 200 combines software and hardware. The controller 200 functions as a controller that controls the whole part of the system management server 2. The network controller 201 acquires information input via the network I/F 210 and transfers information to other apparatuses via the network I/F 210. More specifically, under control of the job controller 202, the network management unit 210 receives the status of the image processing apparatus 1B as the output destination via the networks 4 and 5 and transfers the output job stored in the information DB 203 to the image processing apparatus 1B. That is, the network controller 210 functions as a status acquisition unit.

The job controller 202 controls the image processing apparatuses 1A and 1B via the networks 4 and 5 so that the image processing apparatuses 1A and 1B cooperates with each other and stores and manages the output job such as the print job and the copy job etc. received from the image processing apparatus 1A to be transferred to the image processing apparatus 1B in the information DB 203. In addition, the job controller 202 processes the output job in accordance with various control programs and application programs stored in the HDD 14 etc. preliminarily. Subsequently, the job controller 202 finishes processing the output job in the order determined by the order modifier 205 controlling the network controller 201 and the priority determination unit 204. It should be noted that it is possible that the job controller 202 includes a process executed by the image processing apparatus 1B in the output job if necessary.

The information DB 203 stores information regarding the output job received from the image processing apparatus 1A. In addition, the information DB 203 stores information to operate the image processing apparatuses 1A and 1B cooperating with each other and that the job controller 202 stores and manages the output job and apparatus information regarding apparatuses connected to the networks 4 to 6.

The priority determination unit 204 determines priority of the output job transferred to the image processing apparatus 1B based on the status of the image processing apparatus 1B stored in the information DB 203. The order modifier 205 modifies the order of processing the output job stored in the information DB 203 in accordance with the priority of the output job determined by the priority determination unit 204.

By adopting the configuration described above, the system management server 2 acquires the status of the image processing apparatus 1B as the output destination and modifies the order of processing output job to be transferred to the image processing apparatus 1B in accordance with the status of the image processing apparatus 1B. As a result, in the image processing system, if there is a subsequent output job in a hurry, it is possible to shorten time to process images by the image processing apparatus 1B, enhancing usability.

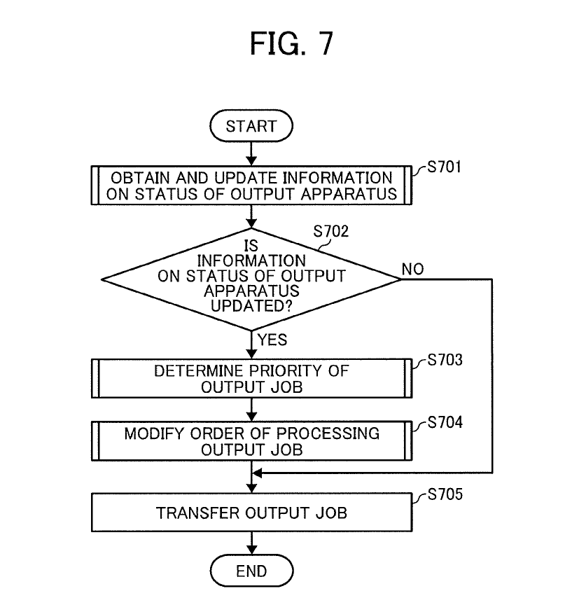

Next, a whole operation of the system management server 2 in this embodiment is described in detail below with reference to FIG. 7.

In the system management server 2 in this embodiment, first, the network controller 201 acquires the status of the image processing apparatus 1B as the output destination via the network I/F 210 under control of the job controller 202 in S701. The network controller 201 transfers the acquired information to the job controller 202. In this case, the job controller 202 refers to the information received from the network controller 201. If the status of the image processing apparatus 1B is changed, information on the status of the image processing apparatus 1B is updated in S701.

Next, in S702, the job controller 202 checks whether or not the status of the image processing apparatus 1B is updated in S701. In this case, if the job controller 202 confirms that the status of the image processing apparatus 1B is not updated (NO in S702), the step proceeds to S705. By contrast, if the job controller 202 confirms that the status of the image processing apparatus 1B is updated (YES in S702), the job controller 202 requests the priority determination unit 204 to determine the priority. As a result, in S703, the priority determination unit 204 determines priority of the output job transferred to the image processing apparatus 1B based on the status of the image processing apparatus 1B acquired in S701. In S703, the order of transferring the output job stored in the information DB 203 is determined. The priority determination unit 204 transfers the result of determining to the order modifier 205.

Next, in S704, under control of the job controller 202, the order modifier 205 modifies the order of processing output job stored in the information DB 203 in accordance with the priority of output jobs determined in S703, and the modification result is transferred to the job controller 202.

Next, in S705, in accordance with the order determined in S704, the job controller 202 transfers the output jobs stored in the information DB 203 to the corresponding image processing apparatus 1B sequentially. As described above, an operation of the whole image processing system in this embodiment finishes. In the image processing system, it is possible to omit S702 and perform the operation after S703 regardless of the status of the image processing apparatus 1B.

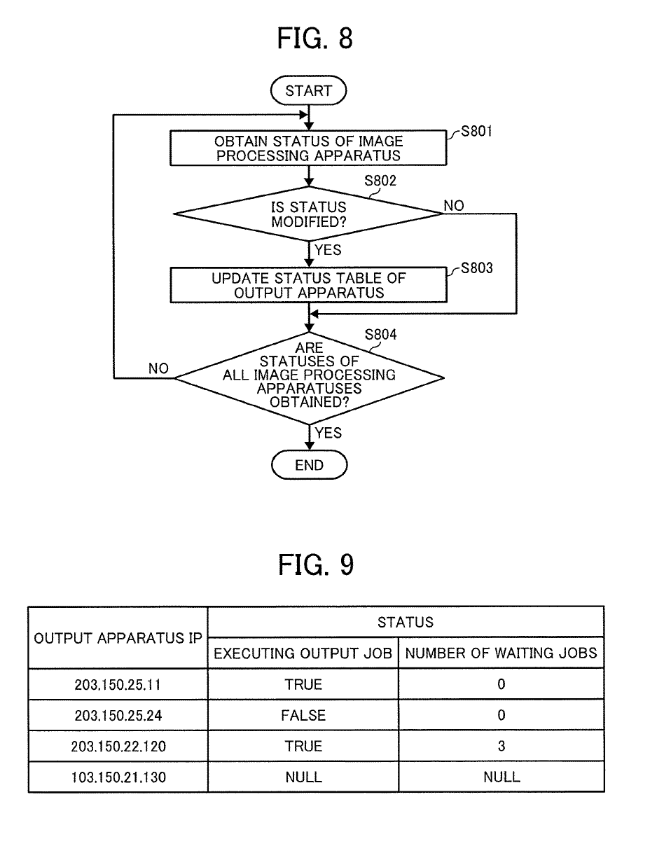

Next, an operation of acquiring the status of the image processing apparatus 1B by the network controller 201 in S701 in FIG. 7 in this embodiment is described in detail below with reference to FIG. 8. It should be noted that the operation in FIG. 8 is repeated at a predetermined constant interval. As a result, in the system management server 2, it is possible to keep the status of the image processing apparatus 1B updated to be the latest status at a constant interval.

As illustrated in FIG. 8, the network controller 201 transfers a request to acquire status to request to transfer each status to the image processing apparatus 1B as the output destination preregistered in the information DB 203. After receiving the request to acquire status from the system management server 2, each image processing apparatus 1B replies back its own status. The network controller 201 receives the information on the status of each image processing apparatus 1B via the network I/F 210 and transfers the received information to the job controller 202.

FIG. 9 is a diagram illustrating an output apparatus status table indicating the status of the image processing apparatus 1B in this embodiment. As illustrated in FIG. 9, the output apparatus status table includes statuses of the image processing apparatus 1B, “output apparatus IP” indicating IP address as an identifier to identify the image processing apparatus 1B as the output apparatus, “executing output job” indicating that the image processing apparatus 1B is processing an image in response to the output job, and “the number of waiting jobs” indicating the number of waiting output jobs that has not been executed yet and stored in the image processing apparatus 1B associated with each other.

After S801, the job controller 202 compares the output apparatus status table received in previous operation from the network controller 201 and that has already been stored with the output apparatus status table received in the current operation from the network controller 201. As a result, the job controller 202 determines whether or not the status of the image processing apparatus 1B has been changed in S802.

In this case, if the job controller 202 determines that the status of the image processing apparatus 1B is not changed (NO in S802), the step proceeds to S804. By contrast, if the job controller 202 determines that the status of the image processing apparatus 1B is changed (YES in S802), the job controller 202 replaces the changed part of the stored output apparatus status table with the corresponding part of the output apparatus status table received in the current operation. As a result, the job controller 202 updates the output apparatus status table in S803.

Next, the job controller 202 refers to the stored output apparatus status table and checks whether or not statuses of all image processing apparatus 1B preregistered in the information DB 203 have been acquired in S804. In this case, if the job controller 202 determines that statuses from all image processing apparatuses have not been acquired yet (NO in S804), the operation from S801 is repeated.

In S804, if the job controller 202 determines that statues of all image processing apparatuses have already been acquired (YES in S804), the operation that the network controller 201 acquires the status of the image processing apparatus 1B in this embodiment ends. In the above description, in S801, the network controller 201 receives the information on the status of each image processing apparatus 1B by transferring the request to acquire status to the image processing apparatus 1B. However, the present invention is not limited to that embodiment. For example, it is possible that the network controller 201 always waits for an asynchronous notification indicating that the status of the image processing apparatus 1B is changed and the operation in S803 described above is performed by regarding a case that the asynchronous notification is received from the image processing apparatus 1B as a trigger.

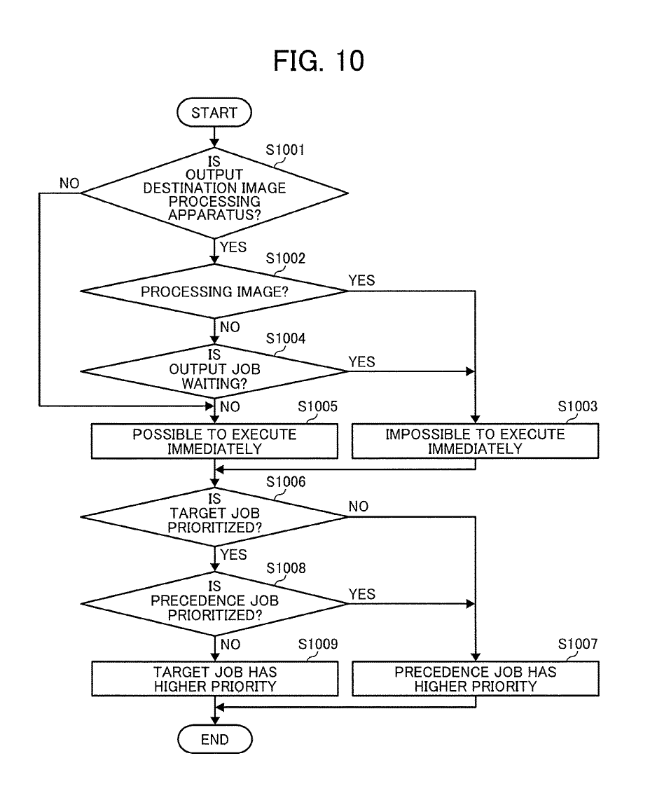

Next, an operation of determining the priority of the output job by the priority determination unit 204 in S703 in FIG. 7 in this embodiment is described in detail below with reference to FIG. 10. In the below description, in the system management server 2, the output job to be processed is referred to as “a target job”, and the stored output job to be executed prior to the target job is referred to as “a precedence job”.

As illustrated in FIG. 10, the priority determination unit 204 acquires the information of the output job stored in the information DB 203 and receives the status of the image processing apparatus 1B from the job controller 202. Subsequently, the priority determination unit 204 refers to the information to determine whether or not the output destination of the target job is the image processing apparatus 1B in S1001.

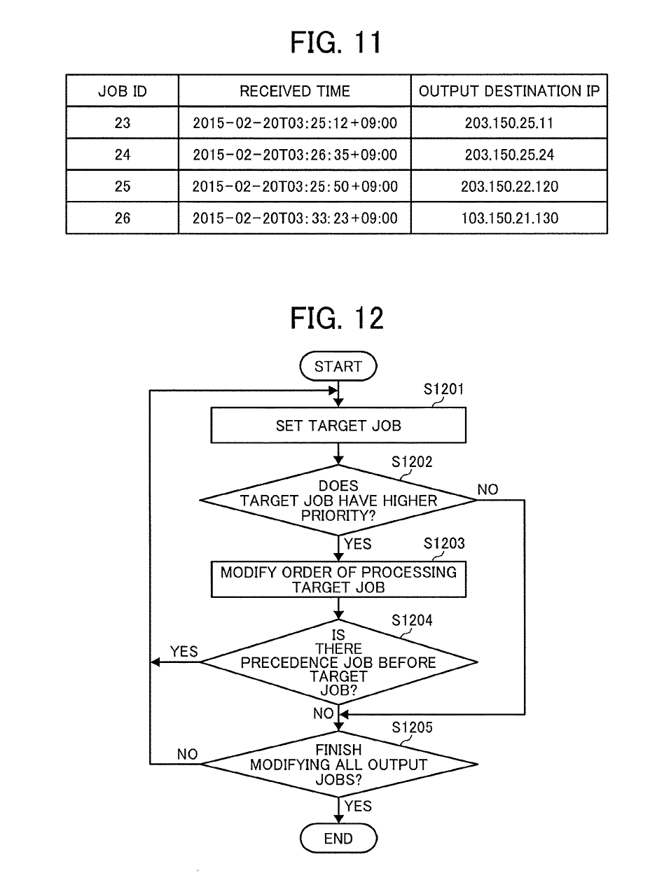

FIG. 11 is a diagram illustrating a job list indicating information on the output job stored in the information DB 203 in this embodiment. In the information DB 203, “job ID” indicating identification identifying the output job received from the image processing apparatus 1A, “received time” indicating time when the network controller 201 receives the output job, and “output destination IP” for specifying the image processing apparatus 1B as the output destination of the output job are stored associated with each other. In the job list, the output job is laid out from the top in descending order of the received time.

In S1001, after referring to the job list, if the output destination IP corresponding to the job ID of the target job is not “203.150.XXX.XXX” (i.e., X can be any value) indicating the IP address of the image processing apparatus 1B, the priority determination unit 204 determines that the output destination of the target job is not the image processing apparatus 1B but the client terminal 3 or the system management server 2 (NO in S1001), and the step proceeds to S1005 (described later).

By contrast, in S1001, if the output destination IP corresponding to the job ID of the target job is “203.150.XXX.XXX”, the priority determination unit 204 determines that the output destination of the target job is the image processing apparatus 1B (YES in S1001) and checks whether or not the image processing apparatus 1B as the output destination of the target job is currently processing an image after receiving another output job in S1002.

In S1002, in the output apparatus status table, the priority determination unit 204 checks whether an item of “executing job” of the output apparatus IP corresponding to the output destination IP corresponding to the job ID of the target job in the job list is “TRUE” or not. As a result, if it is confirmed that the item of “executing job” is “TRUE” (YES in S1002), the priority determination unit 204 determines that the image processing apparatus 1B is in a state that cannot start processing an image for the target job without waiting for processing the image (hereinafter referred to as “impossible to process immediately state”) in S1003. In this case, an operation in S1006 (described later) is performed.

By contrast, if it is confirmed that the item of “executing job” is “FALSE” (NO in S1002), the priority determination unit 204 performs subsequent determination. In S1004, in the output apparatus status table, the priority determination unit 204 checks whether an item of “the number of waiting jobs” of the output apparatus IP corresponding to the output destination IP corresponding to the job ID of the target job in the job list is “0” or not. In this case, if the determination unit 204 determines that “the number of waiting jobs” of the output apparatus IP is not “0”, i.e., a number larger than “0” such as “3” as illustrated in FIG. 9 (YES in S1004), the step proceeds to S1003.

If the determination unit 204 determines that “the number of waiting jobs” of the output apparatus IP is “0” (NO in S1004), the priority determination unit 204 determines that the image processing apparatus 1B is in a state that can start processing an image for the target job without waiting for processing the image (hereinafter referred to as “possible to process immediately state”) in S1005, the target job is configured as a priority job whose process is prioritized.

Next, the priority determination unit 204 confirms whether or not the target job is the priority job configured as described above in S1006. In this case, if the priority determination unit 204 confirms that the target job is not the priority job (NO in S1006), the priority of the precedence job is set higher than the priority of the target job in S1007, and the operation ends. By contrast, in S1006, if the priority determination unit 204 confirms that the target job is the priority job (YES in S1006), it is checked whether or not the precedence job is the priority job in S1008. In this case, if the priority determination unit 204 confirms that the precedence job is the priority job (YES in S1008), the step proceeds to S1007.

In S1008, if the priority determination unit 204 confirms that the precedence job is not the priority job (NO in S1008), the priority of the target job is set higher than the priority of the precedence job in S1009, and the operation ends.

Next, an operation of modifying an order of processing output jobs by the order modifier 205 in S704 in FIG. 7 in this embodiment is described in detail below with reference to FIG. 12.

As illustrated in FIG. 12, after acquiring the information on the output job stored in the information DB 203, the order modifier 205 sets the latest output job added by the inputting image processing apparatus 1A among the acquired output jobs as the target job in S1201. More specifically, in the job list illustrated in FIG. 11, the order modifier 205 sets the output job of the job ID located at the bottom whose received time is the latest as the target job.

Next, after acquiring the result of determining the priority of the output job from the priority determination unit 204, the order modifier 205 determines whether or not the priority of the target job is higher than the priority of the precedence job whose job ID is located at a line upper than the job ID of the target job for one line in the job list in S1202. In this case, if the order modifier 205 determines that the priority of the target job is not higher than the priority of the precedence job (NO in S1202), the step proceeds to S1205 (described later).

If the order modifier 205 determines that the priority of the target job is higher than the priority of the precedence job (YES in S1202), the order modifier 205 modifies the processing order of the target job by replacing the processing order of the target job with the processing order of the precedence job in S1203.

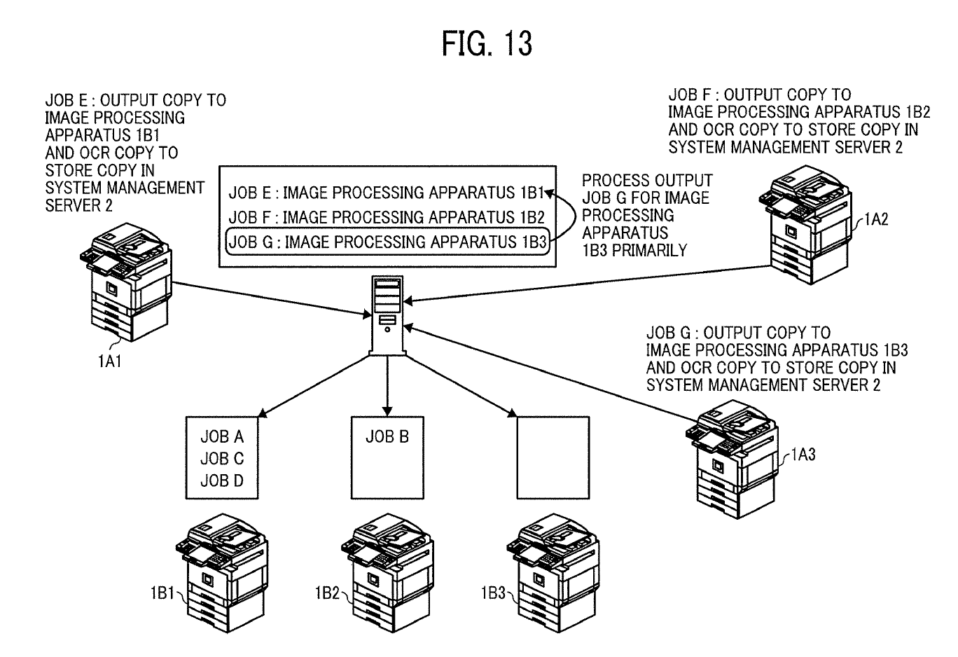

FIG. 13 is a conceptual diagram illustrating the operation in S1203 in this embodiment. As illustrated in FIG. 13, among the output jobs E to G stored in the information DB 203 in the system management server 2, the image processing apparatus 1B3 as the output destination of the output job G added by the image processing apparatus 1A3 afterwards is in the possible to process immediately status. On the other hand, the image processing apparatuses 1B1 and 1B2 as the output destinations of other precedence jobs E and F are in the impossible to process immediately status. Therefore, the priority determination unit 204 sets a higher priority to the output job G compared to other output jobs E and F.

Next, the priority modifier 205 modifies the processing priority of the output job G into a priority higher than the precedence jobs E and F. As a result, in the image processing system, it is possible to prevent a user who puts the output job G later from waiting unnecessarily. Accordingly, it is possible to enhance user convenience.

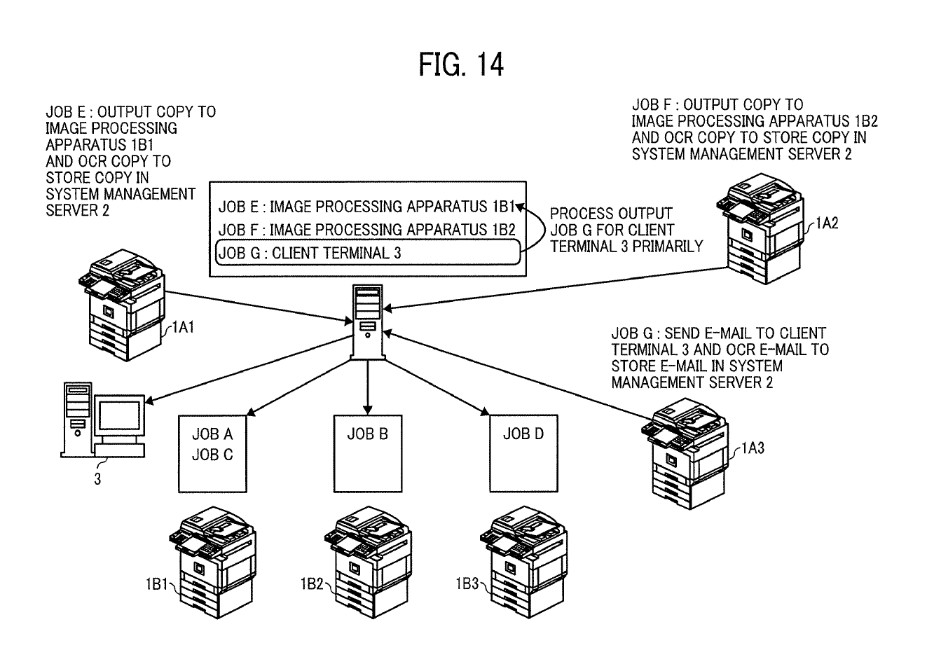

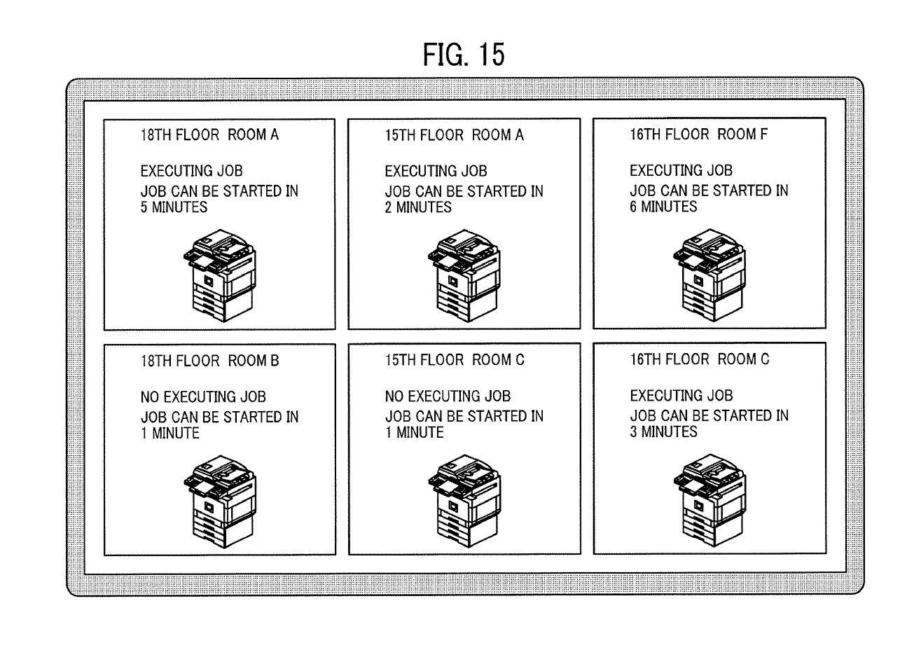

FIG. 14 is a conceptual diagram illustrating another operation in S1203 in this embodiment. As illustrated in FIG. 14, among the output jobs E to G stored in the information DB 203 in the system management server 2, the client terminal 3 as the output destination of the output job G added by the image processing apparatus 1A3 afterwards is in the possible to process immediately status. On the other hand, the image processing apparatuses 1B1 and 1B2 as the output destinations of other precedence jobs E and F are in the impossible to process immediately status. Therefore, the priority determination unit 204 sets a higher priority to the output job G compared to other output jobs E and F.

Next, the priority modifier 205 modifies the processing priority of the output job G into a priority higher than the precedence jobs E and F. As a result, even if all of the image processing apparatuses 1B in the image processing system are in the impossible to process immediately status, it is possible to complete processes in the client terminal 3 and the system management server 2 that do not use the image processing apparatus 1B promptly. Accordingly, it is possible to enhance processing efficiency of the image processing system sufficiently.

Next, after S1203, the order modifier 205 refers to the job list to check whether or not there is a precedence job that is processed in advance of the target job. If there is a precedence job that is processed in advance of the target job (YES in S1204), the order modifier 205 configures the precedence job whose job ID is located at a line upper than the job ID of the current target job for one line in the job list as a new target job in S1201. Subsequently, the operation from S1202 is repeated.

By contrast, in case of determining that there is no precedence job that is processed in advance of the target job (NO in S1204), the order modifier 205 checks whether or not it is finished to modify the processing orders for all output jobs listed in the job list in S1205. If it is not finished to modify the processing orders for all output jobs (NO in S1205), the order modifier 205 configures a precedence job whose processing order has not been modified as a new target job in S1201. Subsequently, the operation from S1202 is repeated.

In case of confirming that it is finished to modify the processing orders for all output jobs (YES in S1205), the operation of modifying the processing orders of the output jobs by the order modifier 205 in this embodiment is completed. If the operation in S702 is omitted in the operation of the image processing system, it is possible to omit the operation in S1205 in FIG. 12. In this case, since it is possible to simplify the operation of modifying the processing orders of the output jobs, it is possible to speed up processing by the system management server 2.

FIG. 15 is a diagram illustrating a screen displayed on the display panel 140 of the image processing apparatus 1A in this embodiment.

The image processing apparatus 1A in this embodiment transfers a request to acquire a list commanding to transfer list information of the image processing apparatus 1B as the output destination registered preliminarily to the system management server 2. Subsequently, the system management server 2 transfers the list information of the image processing apparatus 1B to the image processing apparatus 1A. The list information of the image processing apparatuses 1B includes a status of each image processing apparatus 1B connected to be communicable to the system management server 2 and estimated time when each image processing apparatus 1B completes image processing for the output job. That is, a unit that transfers the list information described above functions as a list information transmitter.

As shown in FIG. 15, after receiving the list information of the image processing apparatus 1B from the system management server 2, the image processing apparatus 1A displays the list of the image processing apparatuses 1B that can be the output destination on a screen of the display panel 140 based on the received list information. The displayed screen includes information that indicates when an output job that will be put afterwards using the image processing apparatus 1A by user operation will start. As a result, by checking the displayed screen on the display panel 140 by user operation, it is possible to select the output destination of the output job to be put efficiently, ensuring superior user convenient.

Consequently, in the image processing system in this embodiment described above, the system management server 2 modifies the processing order of the output job transferred to each image processing apparatus 1B by the priority determination unit 204 and the order modifier 205 in consideration of status of the image processing apparatus 1B as the output destination, and it is possible to perform image processing for the output job put afterwards by user operation. Therefore, it is possible to prevent users from waiting unnecessarily, enhancing user convenience.

In the image processing system in a second embodiment, in addition to the configuration in the first embodiment, the system management server 2 further acquires the status of the image processing apparatus for each image processing function included in the image processing apparatus 1B. The priority determination unit 204 determines the priority of an output job transferred to the image processing apparatus 1B in units of an image processing function based on the status of the image processing apparatus 1B. It should be noted that other configuration in this embodiment is the same as the configuration in the first embodiment described above, and the same symbols are assigned to components same as the first embodiment or corresponding to the first embodiment, and redundant descriptions for those components are omitted.

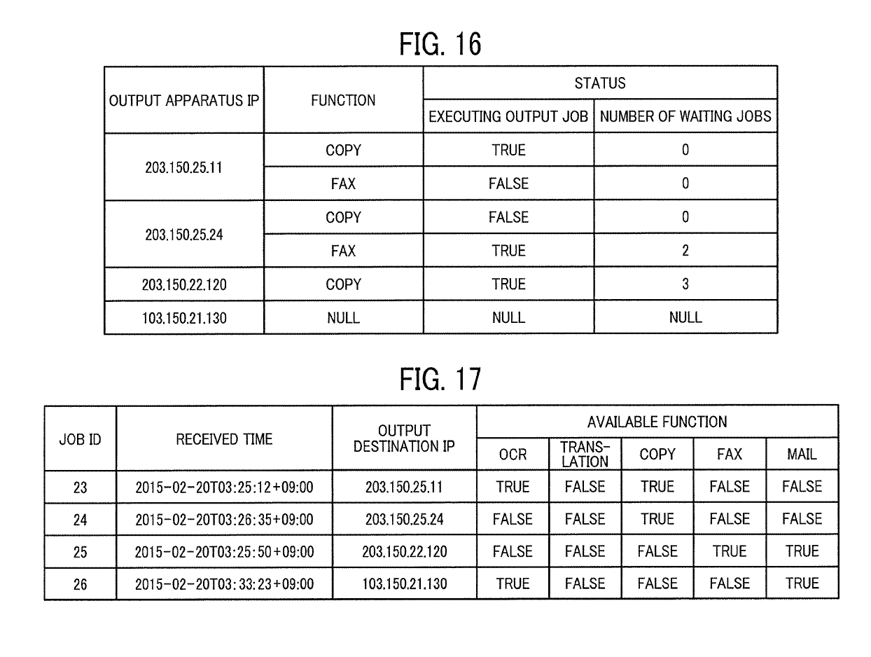

FIG. 16 is a diagram illustrating an output apparatus status table in this embodiment. As illustrated in FIG. 16, in the output apparatus table, in addition to the output apparatus IP, executing output job, and the number of waiting jobs described in the first embodiment, image processing “functions” included in the image processing apparatus 1B are associated with each other. Examples of the image processing functions are OCR function, translation function, copy function, FAX function, and print function etc. However, the configuration in this embodiment is not limited to those functions.

FIG. 17 is a diagram illustrating a job list in this embodiment. In the information DB 203 in this embodiment, in addition to the job ID, received time, and output destination IP described in the first embodiment, available functions utilized in the image processing apparatus 1B as the output destination are stored associated with each other.

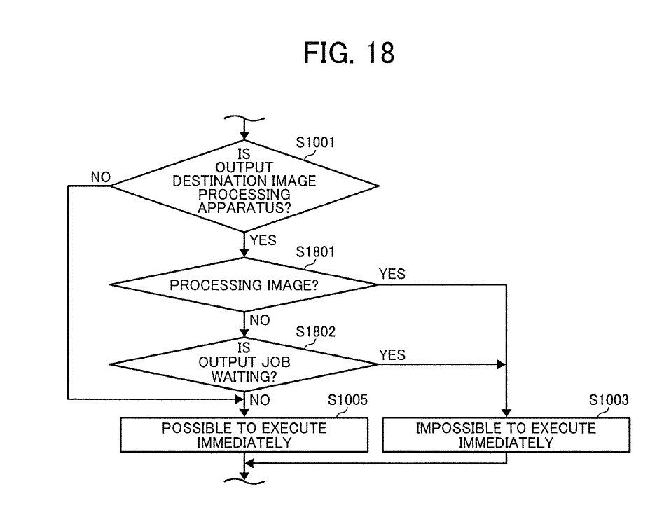

FIG. 18 is a flowchart illustrating an operation in steps S1001 to S1005 in FIG. 10 in this embodiment. As illustrated in FIG. 18, the configuration described above can be implemented by adding predetermined operations between S1001 and S1005. More specifically, the if the output destination of the target job is the image processing apparatus 1B (YES in S1001), the priority determination unit 204 checks whether or not the image processing apparatus 1B is currently executing a function same as the function included in the target job after receiving other output job in S1801.

In S1801, in the output apparatus status table, the priority determination unit 204 checks an item of “executing job” of the output apparatus IP corresponding to the output destination IP corresponding to the job ID of the target job in the job list. Subsequently, it is checked whether or not the item is “TRUE” for the same available function in the job list. In this case, after confirming that the item of executing output job for the output apparatus IP is “TRUE” for the same available function in the job list (YES in S1801), the step proceeds to S1003.

By contrast, in case of being “FALSE” (NO in S1801), the priority determination unit 204 determines whether or not the item of the number of waiting jobs is “0” for the same available function in the job list in S1802. Here, the checked number of waiting jobs described above is the number of waiting jobs of the output apparatus IP corresponding to the output destination IP corresponding to the job ID of the target job in the job list.

In this case, after confirming that the item of the number of waiting jobs for the output apparatus IP is not “0” for the same available function in the job list (YES in S1802), the step proceeds to S1003. By contrast, after confirming that the item of the number of waiting jobs for the output apparatus IP is “0” for the same available function in the job list (NO in S1802), the step proceeds to S1005. The other operations in the priority determination unit 204 in this embodiment are the same as the operations in FIG. 10 described before, so the redundant descriptions are omitted.

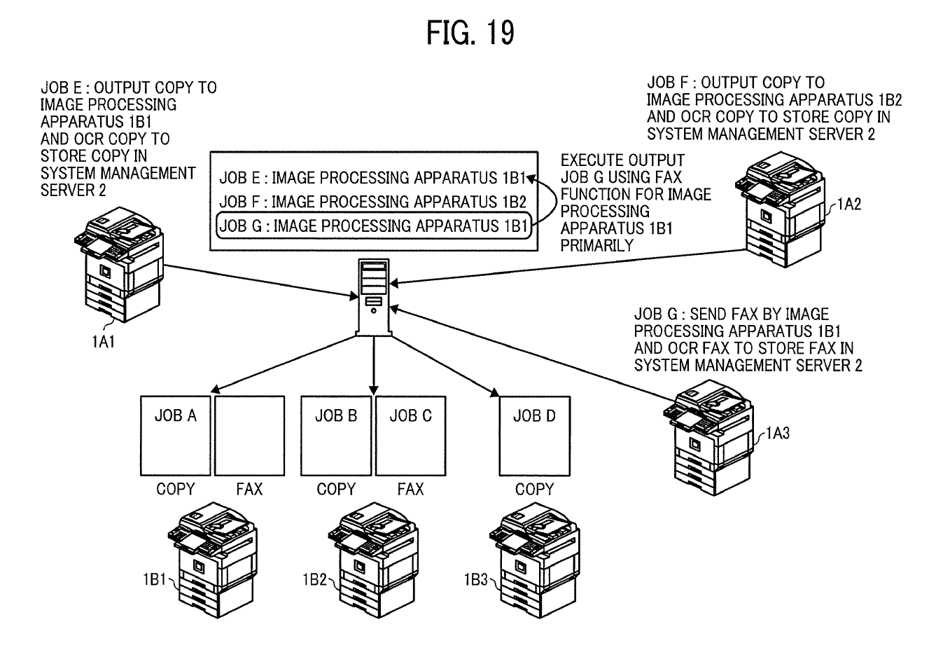

FIG. 19 is a conceptual diagram illustrating an operation in S1203 in FIG. 12 in this embodiment. As illustrated in FIG. 19, among the output jobs E to G stored in the information DB 203 in the system management server 2, the image processing apparatus 1B1 is the output destination of the output job G added by the image processing apparatus 1A3 afterwards. Here, the image processing apparatus 1B1 is in the impossible to execute immediately status for the copy function. However, the image processing apparatus 1B1 is in the possible to execute immediately status for the FAX function included in the output job. In addition, since the image processing apparatus 1B1 as the output destination of the precedence job E and the image processing apparatus 1B2 as the output destination of the precedence job F are in the impossible to execute immediately status, the priority determination unit 204 sets a higher priority to the output job G compared to other output jobs E and F.

Subsequently, the order modifier 205 sets the processing order of the output job G prior to the processing orders of the precedence jobs E and F. As a result, it is possible to achieve the same effect as the first embodiment described before. In addition, in this embodiment, even if the image processing apparatus 1B connected to be communicable to the system management server 2 is in the impossible to execute immediately status for a part of the included functions, the image processing apparatus 1B can accept the output job and execute the image processing if the image processing apparatus 1B is in the possible to execute immediately status for other functions. As a result, it is possible to achieve the purpose of the present invention more suitably.

In the image processing system in this embodiment, in addition to the configuration in the second embodiment, the system management server 2 further assigns a higher priority to a prespecified output job among output jobs from the image processing apparatus 1A compared to other stored output jobs. For example, it is possible to specify the output job on the image processing apparatus 1A by operating the display panel 140 by user operation. It should be noted that other configuration in this embodiment is the same as the configuration in the second embodiment described above, and the same symbols arc assigned to components same as the second embodiment or corresponding to the second embodiment, and redundant descriptions for those components are omitted.

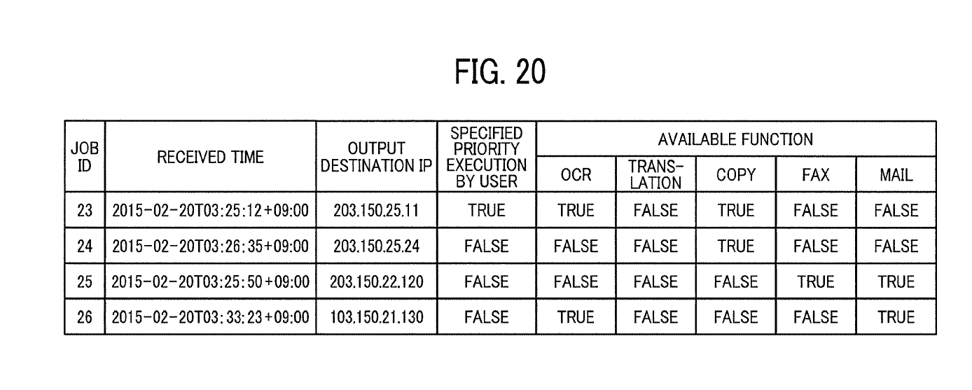

FIG. 20 is a diagram illustrating a job list in this embodiment. As illustrated in FIG. 20, in the information DB 203 in this embodiment, in addition to the job ID, received time, output destination IP, and available function described in the second embodiment, “specified priority execution by user” are stored associated with each other. The specified priority execution by user is information that indicates whether or not it is specified that an output job be processed preferentially by user operation.

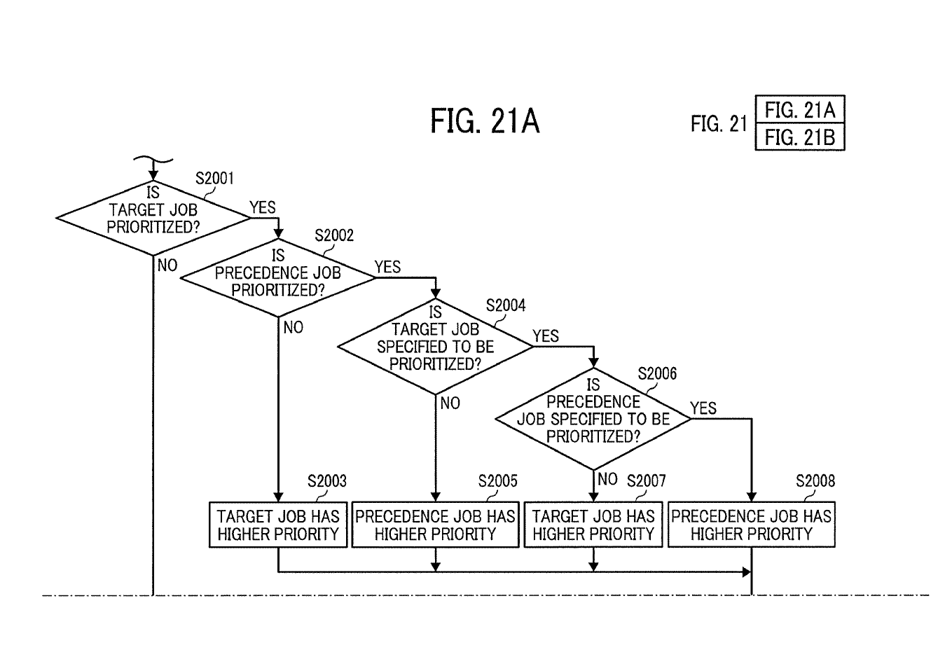

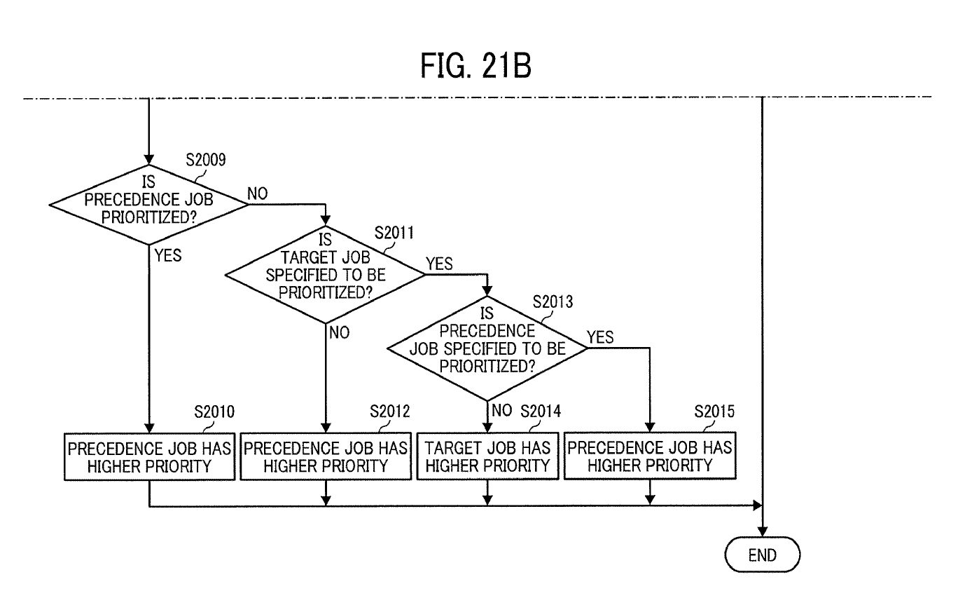

FIGS. 21A and 21B are flowcharts illustrating an operation in steps S1006 to S1009 in FIG. 10 in this embodiment. As illustrated in FIGS. 21A and 21B, the configuration described above can be implemented by adding predetermined operations between S1006 and S1009. More specifically, after performing the operation in S1003 or S1005 in FIG. 10, the priority determination unit 204 checks whether or not the target job is prioritized in S2001. In this case, if it is confirmed that the target job is prioritized (YES in S2001), the priority determination unit 204 checks whether or not the precedence job is prioritized in S2002. If the precedence job is not prioritized (NO in S2002), the priority determination unit 204 sets a higher priority to the target job compared to the precedence job in S2003, and the operation ends.

By contrast, if the precedence job is prioritized (YES in S2002), the priority determination unit 204 refers to the job list in FIG. 20 and checks whether or not the target job is specified to be executed preferentially by user operation compared to other output jobs (hereinafter referred to as “prioritized specified job”) in S2004. If the target job is not the prioritized specified job (NO in S2004), the priority determination unit 204 sets a higher priority to the precedence job compared to the target job in S2005, and the operation ends.

By contrast, in case of confirming that the target job is the prioritized specified job (YES in S2004), the priority determination unit 204 refers to the job list to check whether or not the precedence job is the prioritized specified job in S2006. If the precedence job is not the prioritized specified job (NO in S2006), the priority determination unit 204 sets a higher priority to the target job compared to the precedence job in S2007, and the operation ends.

If the precedence job is the prioritized specified job (YES in S2006), the priority determination unit 204 sets a higher priority to the precedence job compared to the target job in S2008, and the operation ends.

On the other hand, if it is confirmed that the target job is not prioritized (NO in S2001), the priority determination unit 204 checks whether or not the precedence job is prioritized in S2009. If the precedence job is prioritized (YES in S2009), the priority determination unit 204 sets a higher priority to the precedence job compared to the target job in S2010, and the operation ends.

By contrast, in case of confirming that the precedence job is not prioritized (NO in S2009), the priority determination unit 204 refers to the job list to check whether or not the target job is the prioritized specified job in S2011. If the target job is not the prioritized specified job (NO in S2011), the priority determination unit 204 sets a higher priority to the precedence job compared to the target job in S2012, and the operation ends.

By contrast, in case of confirming that the target job is the prioritized specified job (YES in S2004), the priority determination unit 204 refers to the job list to check whether or not the precedence job is the prioritized specified job in S2006. If the precedence job is not the prioritized specified job (NO in S2013), the priority determination unit 204 sets a higher priority to the target job compared to the precedence job in S2014, and the operation ends.

If the precedence job is the prioritized specified job (YES in S2013), the priority determination unit 204 sets a higher priority to the precedence job compared to the target job in S2016, and the operation ends.

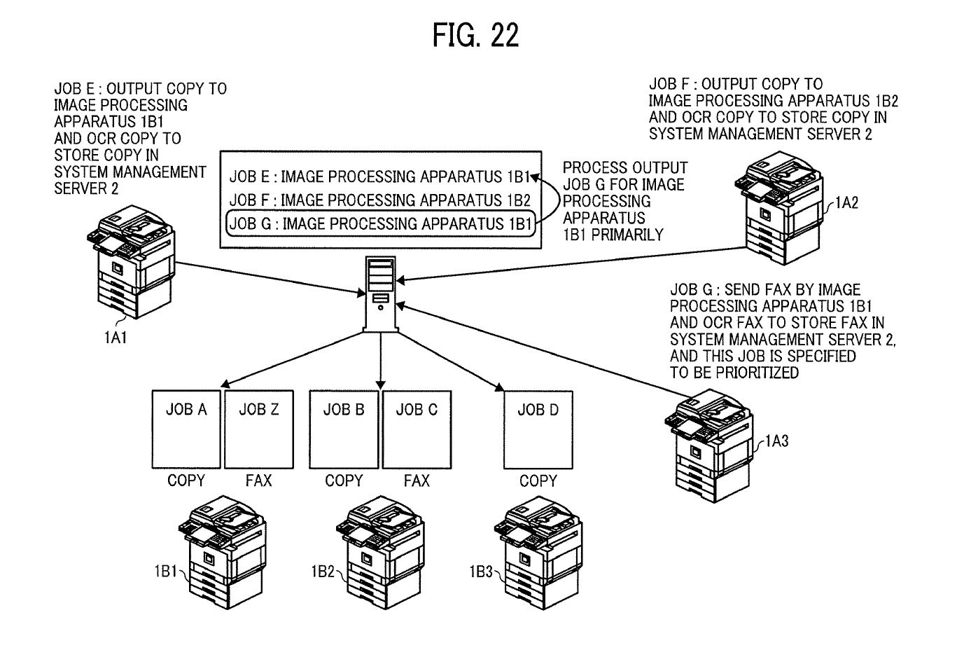

FIG. 22 is a conceptual diagram illustrating an operation in S1203 in FIG. 12 in this embodiment. As illustrated in FIG. 22, among the output jobs E to G stored in the information DB 203 in the system management server 2, the image processing apparatus 1B1 is the output destination of the output job G added by the image processing apparatus 1A3 afterwards. While the image processing apparatus 1B1 is in the impossible to execute immediately status for all image processing functions, the output job of the image processing apparatus 1B1 is configured as the prioritized specified job. In addition, since the image processing apparatus 1B1 as the output destination of the precedence job E and the image processing apparatus 1B2 as the output destination of the precedence job F are in the impossible to execute immediately status, the priority determination unit 204 sets a higher priority to the output job G compared to other output jobs E and F.

Subsequently, the order modifier 205 sets the processing order of the output job G prior to the processing orders of the precedence jobs E and F. As a result, it is possible to achieve the same effect as the second embodiment described before. Furthermore, in this embodiment, even if the image processing apparatus 1B connected to be communicable to the system management server 2 is in the impossible to execute immediately status for all functions, it is possible to execute the image processing earlier as user intention by prespecifying that an output job is executed in preference to other output jobs by using the display panel 140 by user operation. As a result, it is possible to enhance the user convenience.

In this embodiment, in the image processing system, the image processing apparatuses 1A and 1B are connected to the system management server 2 via the networks 4 and 5. However, it is possible to configure the system in the way that at least one of the image processing apparatuses 1A and 1B includes the functions of the system management server 2. By configuring the image processing system in this embodiment as described above, since it is possible to implement the system without the system management server 2, it is possible reduce an initial cost and running cost for the image processing system.

In the embodiments described above, a system that multiple image processing apparatuses cooperates to process operations, reduces unnecessary waiting time for users, and enhances user convenience is provided.

The present invention also encompasses a non-transitory recording medium storing a program that executes an information processing method. The information processing method includes the steps of receiving multiple output commands from one or more inputting image processing apparatuses, each command instructing to output image data through an outputting information processing apparatus, acquiring a status of the outputting image processing apparatus, determining priorities of the multiple output commands to be transferred to the outputting image processing apparatus based on the acquired status of the outputting image processing apparatus, and modifying an order of processing the output commands in accordance with the determined priorities of the output commands.

Numerous additional modifications and variations are possible in light of the above teachings. It is therefore to be understood that within the scope of the appended claims, the disclosure of the present invention may be practiced otherwise than as specifically described herein.

For example, elements and/or features of different illustrative embodiments may be combined with each other and/or substituted for each other within the scope of this disclosure and appended claims.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An information processing apparatus, comprising:
circuitry to:
receive multiple output commands from one or more inputting image processing apparatuses, each command instructing to output image data through an outputting information processing apparatus;
acquire a status of the outputting image processing apparatus;
determine priorities of the multiple output commands to be transferred to the outputting image processing apparatus based on the acquired status of the outputting image processing apparatus; and
modify an order of processing the output commands in accordance with the determined priorities of the output commands.

2. The information processing apparatus according to claim 1, wherein the circuitry determines priorities so as to preferentially execute the output command that the outputting image processing apparatus can start the execution without waiting for processing an image among the multiple output commands.

3. The information processing apparatus according to claim 2, wherein, when the outputting image processing apparatus includes a plurality of outputting image processing apparatuses, the circuitry further determines if any one of the outputting image processing apparatuses cannot immediately start image processing based on the output command, and preferentially executes the output command for image processing by one of the outputting image processing apparatuses other than the outputting image processing apparatus that cannot immediately start image processing.

4. The information processing apparatus according to claim 1, wherein, when the outputting image processing apparatus includes a plurality of outputting image processing apparatuses, the circuitry further determines if any one of the outputting image processing apparatuses cannot immediately start image processing based on the output command, and if all of the outputting image processing apparatuses cannot start image processing, preferentially executes the output command that does not require image processing.

5. The information processing apparatus according to claim 1, wherein the circuitry:
acquires the status of the outputting image processing apparatus by each image processing function included in the outputting image processing apparatus; and
determines the priority of the output commands to be transferred to the outputting image processing apparatus in units of the image processing function based on the status of the outputting image processing apparatus.

6. The information processing apparatus according to claim 1, further comprising a transmitter to transfer display information for displaying time when the outputting image processing apparatus can start image processing based on the output command received from the inputting image processing apparatus.

7. The information processing apparatus according to claim 1, wherein the circuitry assigns a higher priority to each one or more predetermined output commands among the multiple output commands received from the inputting image processing apparatus compared to other output commands stored in a memory.

8. An image processing system, comprising:
at least one inputting image processing apparatus to generate an output command instructing to output image data through an outputting information processing apparatus;
an information processing apparatus connected to the inputting image processing apparatus via a network and store multiple output commands received from the at least one inputting image processing apparatus; and
at least one outputting image processing apparatus to execute image processing in response to receiving the output command from the information processing apparatus, wherein the information processing apparatus includes:
circuitry to:
acquire a status of the outputting image processing apparatus;
determine priorities of the multiple output commands to be transferred to the outputting image processing apparatus based on the acquired status of the outputting image processing apparatus; and
modify an order of processing the output commands in accordance with the determined priorities of the output commands.

9. A method of processing information, comprising:
receiving multiple output commands from one or more inputting image processing apparatuses, each command instructing to output image data through an outputting information processing apparatus;
acquiring a status of the outputting image processing apparatus;
determining priorities of the multiple output commands to be transferred to the outputting image processing apparatus based on the acquired status of the outputting image processing apparatus; and
modifying an order of processing the output commands in accordance with the determined priorities of the output commands.
